(19) United States
(12) Patent Application Publication
(10) Pub. No.: US 2021/0277510 A1
(43) Pub. Date: Sep. 9, 2021

(54) METHOD FOR APPLYING A THERMAL BARRIER

(71) Applicant: Safran Aircraft Engines, Paris (FR)

(72) Inventors: Pascal Fabrice BILHE, Moissy-Cramayel Cedex (FR); Laurent Paul Dudon, Moissy-Cramayel Cedex (FR); Pascal Jacques Raymond Martinet, Moissy-Cramayel Cedex (FR)

(73) Assignee: Safran Aircraft Engines, Paris (FR)

(21) Appl. No.: 16/811,828

(22) Filed: Mar. 6, 2020

(51) Int. Cl. C23C 4/134; B28B 11/04; B05D 3/14; C23C 4/18; C04B 41/00

(52) U.S. Cl. CPC C23C 4/134; B28B 11/048; B28B 11/0818; C23C 4/18; C04B 41/0054; B05D 3/148

(57) ABSTRACT

A bond sublayer is applied to a part and a ceramic layer is deposited on the bond sublayer by plasma spraying. The ceramic layer is then sintered.

### TECHNICAL FIELD AND PRIOR ART

The present invention is directed towards thermal barriers.

It more particularly concerns thermal barriers of YSZ ceramic (C) type with transverse microcracks.

In aircraft turbines as in land-based turbines, the constituent parts of the High Pressure body such as the combustion chamber, fuel supply nozzles, distributors and high pressure turbine blades (HPD and HPP) are protected by a thermal insulating system of refractory “thermal barrier” type.

The integrity of this system is determinant to meet the duty requirements of the protected parts.

However, during normal operation problems are commonly observed related to erosion by hot gases. In gas turbomachines, erosion is the combined result of erosion generated by multiple explosions on the surface of deposits (cavitation phenomena) and erosion due to thermal cycling related to engine switch-off.

In both cases the result is a decrease in insulation thickness via erosion or micro-spallation leading to lesser thermal protection of the underlying substrate. The lifetime of the parts is thereby reduced and they require frequent restoration giving rise to a problem in terms of maintenance organisation and in terms of cost.

For thermal barriers deposited by Electron Beam Physical Vapour Deposition (EBPVD), thermal barriers having transverse microcracks obtained by atmospheric plasma spraying (APS) are currently the best coating, meeting requirements both of erosion-resistance and resistance to thermal cycling.

This technique is used in particular for solid circular parts such as parts of combustion chambers or for smaller parts such as kerosene injection nozzles.

As illustrated in FIG. 1, the thermal barrier TB deposited on a part P is then conventionally composed of:
a sublayer BSL in alloy deposit of MCrAlY type (where M corresponds to Ni, Co, Fe and NiCo) forming a so-called bond sublayer (BSL);
a thermally insulating layer C in YSZ (yttria Y₂O₃ stabilised zirconia ZrO₂) ceramic (C).

Each of the two layers BSL and C of the thermal barrier TB is deposited by thermal spraying using a plasma arc torch.

For an example of embodiment of said thermal barrier reference can advantageously be made to patent application FR 2,854,166 which describes a process to obtain a thermal barrier with a layer C in ceramic (C) and bond sublayer (BSL) having transverse microcracks (with main component normal to the substrate) which impart some flexibility to the thermal barrier and allow the absorbing of multiple differential thermal-expansion cycles at the substrate/thermal barrier interface but also in the thermal barrier.

### DISCLOSURE OF THE INVENTION

One general objective of the invention is to improve the erosion resistance and resistance to micro-spallation of thermal barriers having a YSZ ceramic layer (C) with transverse microcracks, in parts such as turbine parts.

A further objective of the invention is to improve the erosion resistance of the insulating YSZ ceramic (C) layer C whilst maintaining an operating range (range of temperature resistance in particular) that is almost equivalent without having to make any major changes however to total production time and cost of thermal barriers.

For this purpose the invention proposes a process to obtain a thermal barrier with transverse microcracks whereby a layer C in ceramic (C) of YSZ type is deposited on a bond sublayer (BSL) via thermal spraying using a plasma arc torch, said bond sublayer (BSL) itself being deposited on the part to be protected. Post-treatment by sintering is performed by scanning the layer C in ceramic (C) with the beam of the plasma arc torch, the temperature at the point of impact of the beam on the layer C of ceramic (C) during this scanning being between 1300° C. and 1700° C., preferably between 1400° C. and 1450° C.

It is effectively known that a ceramic (C) of YSZ type can be sintered on and after a temperature of 1300° C. in air.

By sintering here and in the remainder of this text is meant treatment to consolidate a material (e.g. a powder), obtained by minimising the energy of the system by means of a supply of energy (thermal, mechanical, laser, plasma torch . . . ) but without fusion of at least one of the constituents. Said sintering of the layer in ceramic (C) causes hardening thereof; it reduces porosity and leads to improved erosion resistance.

To be sintered the ceramic (C) must remain within a range:
of temperature sufficiently high for the sintering reaction to be able to take place and
of time of sufficient length for conducting of the sintering reaction
with porosity and unfused particle levels as sprayed that are low (<5%).

Yet on large-size parts the thermal barrier cools too rapidly preventing the sintering reaction from being continued over a sufficient time range.

The use of a plasma torch provides full control over sintering.

The process can also advantageously be used for parts of small size.

During said sintering post-treatment the temperature of the beam spot on the surface of the layer C in ceramic (C) is permanently measured and the parameters of the torch are adjusted as a function of this measurement. The key parameters to be controlled are in particular:
torch-part distance (related to Temperature T);
rate of travel v of the torch and percentage coverage C, the rate of travel v and percentage coverage both being related to exposure time to said temperature T.

Sintering is a phenomenon having a diffusional driving force that is a function of time and temperature. Controlling of parameters provides better sintering.

In addition, the surface of the part opposite the layer C in ceramic (C) is cooled so that it is held at a temperature generally lower than 950° C.

The proposed post-treatment can be used for a ceramic layer (C) already microcracked after it has been deposited.

The post-treatment therefore allows improved sintering thereof.

As a variant, the sintering post-treatment may generate the microcracks after the spraying of a standard thermal barrier (non-microcracked).

At the post-treatment step, the surface of the layer of ceramic (C) is scanned by the beam to reach a temperature of between 1300° C. and 1700° C. for a few seconds, typically between five seconds and about twenty seconds.

The proposed process advantageously finds application to parts of large size, the microcracked thermal barriers coated onto this type of part conventionally being scarcely satisfactory in terms of erosion resistance.

### DESCRIPTION OF THE FIGURES

Other characteristics and advantages of the invention will become further apparent from the following description given solely as a non-limiting illustration with reference to the appended Figures in which:

FIG. 1 gives a schematic cross-sectional view of a part which is for example a part used in a turbine e.g. an aircraft turbine coated with a bond sublayer (BSL) and thermal barrier;

FIG. 2 schematically illustrates the major steps of a possible embodiment of the invention;

FIG. 3 is a schematic illustrating the implementation of a post-treatment sintering step, the cooling stream being blown onto the side of the inner wall opposite the thermal spot and not being shown in this schematic;

FIG. 4 is a schematic planar view illustrating the movement of the thermal spot over a part coated with the thermal barrier, the part being scanned having small dimensions.

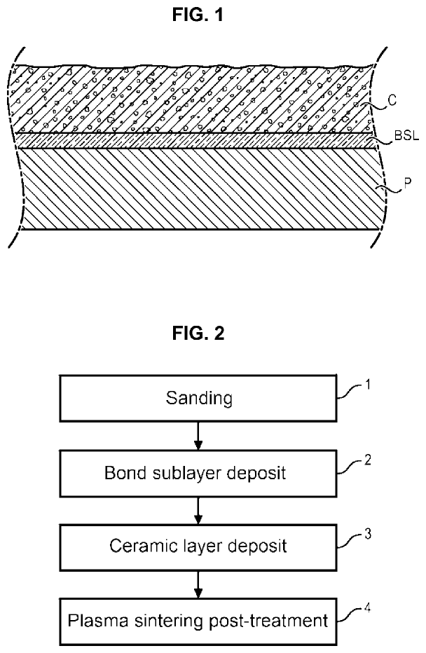

### EXAMPLES OF EMBODIMENT

As illustrated in FIG. 2, a possible embodiment comprises the following different steps:
preparing the surface of the part P to be protected by sanding (step 1);
forming the bond sublayer (BSL) by APS deposit on the surface (step 2);
forming the layer C in insulating, refractory YSL ceramic (C), also by APS deposit (step 3);
post-treatment by sintering the ceramic (C) to improve its erosion resistance (step 4).

Large-Size Parts

A part P to be coated may be a part of large dimensions e.g. a wall of a combustion chamber.

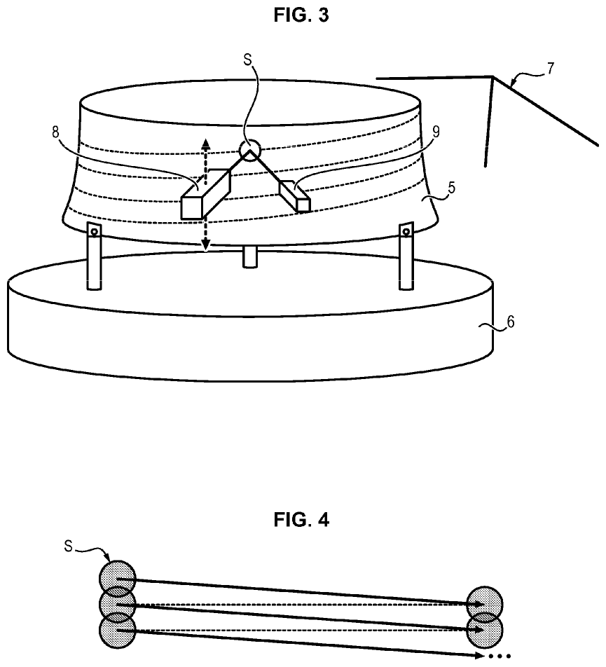

Said combustion chamber wall may be in the form of a slightly truncated metal part 5 (FIG. 3) having a diameter at the two ends in the order 600 and 800 mm and height of 800 mm for example.

This part is made of a nickel- or cobalt-based super alloy. It has a thickness of 1 to 2 mm for example.

For the implementation of steps 1 to 4, this part 5 is placed on a turntable 6 in a spray cabin 7.

A plasma arc torch 8, following usual methods, ensures the depositing of the bond sublayer (BSL) (step 2) followed by depositing of the layer C in ceramic (C) thereupon (step 3).

In particular, the depositing of the layer C in ceramic (C) can be performed under conditions ensuring microcracking as sprayed (cf. aforementioned FR 2854166).

It can also be carried under standard conditions not generating any microcracks.

The post-treatment at step 4 is then carried out:
in the first case to improve the sintering of the thermal barrier TB;
in the second case to microcrack the layer C in ceramic (C) and the thermal barrier TB.

It will be noted that to enhance cracking during the post-treatment at step 4, a fine thermal spray powder is used of small particle size.

A fine-particulate powder of fused crushed type (fusion in arc furnaces followed by cooling and crushing, having a particle size between 10 and 60 μm) has the advantage of fusing more homogeneously.

It provides low porosity for the ceramic layer (C) (<5%).

It more easily provides for total absence of unfused particles.

It therefore allows the sintering and microcracking reaction.

A possibly suitable powder is Amperit 831 for example by HC Starck.

Also, the spray powder is also selected so that under standard spraying conditions (those used for non-microcracked coatings) the coating C derived from this powder exhibits bonding strength of at least 25 MPa onto the bond sublayer (BSL) facilitating transverse microcracking.

High bonding forces between the layer C and sublayer BSL promote the generation of microcracks in the thickness of the coating rather than along the sublayer/layer interface.

The use of a fused, crushed powder allowing bonding strength of at least 25 MPa of the coating contributes towards the generated microcracking of the thermal barrier TB—during the post-spray heat treatment described below (step 4)—solely in the transverse direction in the proportion of at least 20 microcracks/20 mm.

The implementation of this post-treatment step 4 is performed as follows.

All masks and protective items are removed from part 5, these no longer being useful since part 5 will not be subjected to any further spraying.

It is not removed from the turntable 6 of the spray cabin, unless logistics so require.

The torch 8 is set in operation and the part is scanned therewith prior to setting the turntable in rotation to heat some points of the thermal barrier TB to 1400-1450° C.

A previously calibrated pyrometer 9 placed in position ensures real-time temperature measurements at the point of impact of the torch 8. This pyrometer 9 is embedded in a robot in the spray cabin 7, inside part 5.

It targets the point of impact of the spot S of the torch 8 on the coated part 5.

It is selected to allow temperature measurements between 1200 and 1700° C. If the ceramic (C) is a YSZ layer, the pyrometer is selected so as to operate above 8 μm, preferably between 11 and 13.6 μm e.g. at 12.6 μm (Christiansen wavelength).

At these values:
the YSZ displays zero transmittance (no parasitic measurements);
its emittance is practically temperature-independent (no correction);
its emissivity is in the order of 1 which allows direct read-off of temperature under normal conditions of the black body.

It will be noted that the temperature on the surface of the ceramic (C) is a function of:
the speed of rotation of the part;
torch-coated surface distance;
percentage coverage.

The parameters related to initiation of the plasma at the outlet of the torch (plasmagenous gas flow rate, voltage and intensity . . . ), once plasma stability has been reached, are maintained independent of time.

Therefore the control of temperature on the surface of the layer C in ceramic (C) provides control over sintering kinetics.

When the turntable 6 is set in motion, the torch 8 is moved in vertical scanning direction which combines with the movement in rotation of the turntable to allow the spot S sprayed by the torch onto the thermal barrier to ensure helical scanning thereof.

The plasma parameters are controlled so that the surface temperature measured by the pyrometer remains within a temperature range of 1400-1600° C. (optimal sintering temperature).

Typically the part 6 is fully treated within about 35 minutes.

The torch 8 is an F4 model for example equipped with a 6 mm nozzle or 8 mm nozzle producing a wider thermal spot.

The speed of rotation of the turntable 6 is 1 m/min for example, whilst the helical pitch described on the thermal barrier is 12 mm.

The distance between the nozzle outlet of the torch and the surface of the part varies between 30 and 70 mm depending on the diameter of said nozzle and the power parameters of the torch.

Other parameter combinations are evidently also possible.

It will be noted however that the surface temperature must be at least 1300° C., (preferably between 1400° C. and 1450° C.) and must be reached within less than 5-10 seconds (extrapolation at zero speed) otherwise heat transfer into the part will take place rather than sintering treatment. Also, during the post-treatment, the surface of layer in ceramic (C) is scanned by the beam to reach a temperature of between 1300° C. and 1700° C. for a few seconds, typically between five seconds and about twenty seconds to cause the hardening reaction.

It is also recommended that the temperature on the opposite side, the metal side, should not exceed 950° C., preferably 900° C. (possibly a peak of 1000° C.) otherwise the sublayer may be deteriorated by oxidation.

In particular to prevent heating of the metal portion of the part, this portion is cooled throughout the entire treatment performed at step 4. For this purpose, multiple powerful air jets are used. These can be directed both onto the metal side and onto the ceramic side (C). Evidently on the ceramic (C) side no flow is directed close to the spot, the air streams being kept away therefrom by at least +/−100 mm.

Said cooling:
stabilises the overall temperature of the part more rapidly, right at the start of treatment;
prevents overheating which may damage the metal portions of the part.

The temperature on the side opposite the thermal barrier, on the metal side, is permanently measured either by thermocolour thermal patches or by pyrometry or by thermocouples.

The parameters of the torch and of blow cooling are controlled to allow this temperature to be maintained at the desired level.

Parts of Small Dimensions

The sintering treatment at step 4 can also be used to microcrack the thermal barrier TB coating of small-size parts such as kerosene injection nozzles for example.

During conventional depositing of a thermal barrier system, a part of this type undergoes a temperature rise. This temperature is sufficiently high so that the sintering of the ceramic (C) (initially in pre-sintered form) is able to be improved by implementing post-treatment sintering (step 4).

As with the case for large-size parts, to form layer C a fine spray powder of small particle size is used allowing said layer C to exhibit bonding strength higher than 25 MPa onto the bond sublayer (BSL) whilst at the same time ensuring porosity lower than 5% and no unfused particles.

The post-treatment of layer C in ceramic (C) by sintering (step 4) and the controlling of temperature during this post-treatment are similar to those described above for a combustion chamber wall.

In particular the pyrometer used may be of the same type.

However the geometry of the part to be treated being different, heating is controlled by linear scanning of the spot of the torch 8 over the height of the part to be treated.

An example of scanning is of the type illustrated in FIG. 4 for example. The scan rate is 1 m/min, with a pitch of 12 mm. Coverage of the thermal spot from one pass to another is at least 10%.

1. A method for obtaining a thermal barrier on a part to be protected, the method comprising:
forming a bond sublayer on a surface of the part to be protected by plasma spraying, the bond sublayer comprising MCrAlY, wherein M comprises Ni, Co, Fe, or NiCo;
depositing a ceramic layer on the bond sublayer by thermal spraying using a plasma arc torch, the ceramic layer comprising Yttria-Stabilized Zirconia; and
sintering the ceramic layer by scanning the ceramic layer with a beam of the plasma arc torch, wherein the sintering comprises heating a surface of the ceramic layer to a temperature at a point of impact of the beam on the surface of the ceramic layer between 1300° C. and 1700° C.

2. The method according to claim 1, wherein the sintering comprises heating the surface of the ceramic layer to temperature at the point of impact of the beam on the surface of the ceramic layer between 1400° C. and 1450° C.

3. The method according to claim 1, wherein, during the sintering, the temperature of the point of impact of the beam on the surface of the ceramic layer is measured and parameters of the plasma arc torch are controlled as a function of the measured temperature.

4. The method according to claim 1, wherein a spray powder used to deposit the ceramic layer is a powder of fused and crushed type having a particle size of between 10 and 60 μm.

5. The method according to claim 4, wherein the sintered ceramic layer has less than 5% porosity.

6. The method according to claim 4, wherein the sintered ceramic layer has bonding strength higher than 25 MPa with the bonding sublayer.

7. The method according to claim 1, wherein a surface of the part opposite the ceramic layer is held at a temperature lower than 950° C. during the sintering.

8. The method according to claim 1, wherein the depositing the ceramic layer on the bond sublayer by thermal spraying comprises generating transverse microcracks in the ceramic layer.

9. The method according to claim 1, wherein the sintering the ceramic layer comprises generating transverse microcracks on the ceramic layer.

10. The method according to claim 1, wherein the part is a turbine part.

11. The method according to claim 1, wherein during the sintering, the surface of the ceramic layer is scanned by the beam so as to reach a temperature of between 1300° C. and 1700° C. for five seconds to twenty seconds.

12. The method according to claim 1, wherein during the forming the bond sublayer, the depositing the ceramic layer, and the sintering the ceramic layer, the part is placed on a turntable in a spray chamber.
